(19) United States
(12) Patent Application Publication
(10) Pub. No.: US 2019/0223057 A1
(43) Pub. Date: Jul. 18, 2019

(54) METHOD AND APPARATUS FOR CONDITIONAL HANDOVER IN COMMUNICATION SYSTEM

(71) Applicant: ELECTRONICS AND TELECOMMUNICATIONS RESEARCH INSTITUTE, Daejeon (KR)

(72) Inventors: Hyun Seo PARK, Daejeon (KR); Eun Kyung KIM, Daejeon (KR); Tae Joong KIM, Daejeon (KR); An Seok LEE, Daejeon (KR); Yu Ro LEE, Daejeon (KR); Hyun LEE, Daejeon (KR); Heesoo LEE, Daejeon (KR)

(21) Appl. No.: 16/244,450

(22) Filed: Jan. 10, 2019

(30) Foreign Application Priority Data
Jan. 16, 2018 (KR) 10-2018-0005774
Jan. 7, 2019 (KR) 10-2019-0001578

(51) Int. Cl. H04W 36/00; H04W 36/08; H04W 36/26; H04W 36/38; H04W 76/19; H04W 76/27

(52) U.S. Cl. CPC H04W 36/0016; H04W 36/0085; H04W 36/08; H04W 76/27; H04W 36/38; H04W 76/19; H04W 36/26

(57) ABSTRACT

An operation method of a terminal in a communication system includes transmitting a measurement report message of each of one or more neighbor base stations to a source base station, the one or more neighbor base stations satisfying a handover (HO) preparation event; receiving, from the source base station, a conditional HO command message of each of at least one of neighbor base stations among the one or more neighbor base stations; determining a target base station based on priority of a neighbor base station which satisfies a HO execution event among the at least one of neighbor base stations; and performing a handover with the target base station.

### CROSS-REFERENCE TO RELATED APPLICATIONS

This application claims priority to Korean Patent Application Nos. 10-2018-0005774, filed Jan. 16, 2018, and 10-2019-0001578, filed Jan. 7, 2019 in the Korean Intellectual Property Office (KIPO), the entire contents of which are hereby incorporated by reference.

### BACKGROUND

### 1. Field of the Invention

The present disclosure relates to a conditional handover, and more particularly, to a method and an apparatus for determining a handover execution time and a target base station in the conditional handover.

### 2. Description of Related Art

With the development of information and communication technology, various wireless communication technologies are being developed. Typical wireless communication technologies include long term evolution (LTE), new radio (NR), etc. defined in the 3rd generation partnership project (3GPP) standard. The LTE may be one of the fourth generation (4G) wireless communication technologies, and the NR may be one of the fifth generation (5G) wireless communication technologies.

The 5G communication system (e.g., the communication system supporting the NR) using a frequency band (e.g., frequency band above 6 GHz) higher than a frequency band (e.g., frequency band below 6 GHz) of the 4G communication system (e.g., the communication system supporting the LTE) as well as the frequency band of the 4G communication system is being considered for processing of rapidly increasing wireless data after commercialization of the 4G communication system. The 5G communication system can support enhanced mobile broadband (eMBB) services, ultra-reliable and low-latency communication (URLLC) service, and massive machine type communication (mMTC) services.

Meanwhile, in a communication system, a terminal may change a cell (e.g., base station) to which the terminal is connected through a handover procedure or a cell (re)selection procedure. In the handover procedure, the terminal may measure strengths of signals received from neighbor base stations, and report measurement results to a source base station. The source base station may receive the measurement results from the terminal, and select a target base station to which the terminal is to be handed over based on the measurement results. That is, the target base station to which the terminal is to be handed over may be selected by the source base station. When a handover preparation is completed at the target base station selected by the source base station, the source base station may transmit to the terminal a handover (HO) command message indicating handover to the target base station. When the HO command message is received from the source base station, the terminal may perform an access procedure with the target base station.

When the measurement results for the neighbor base stations are not transferred to the source base station in real time, or when a received signal strength of the target base station is lower than a received signal strength of any other neighbor base station at the time of execution of the handover to the target base station, the handover may fail. Also, even after the handover to the target base station is completed, a handover to a neighbor base station having a received signal strength larger than that of the target base station may be performed again.

### SUMMARY

Accordingly, embodiments of the present disclosure provide a method and an apparatus for determining a handover execution time and a target base station of a conditional handover.

According to embodiments of the present disclosure, an operation method of a terminal in a communication system may comprise transmitting a measurement report message of each of one or more neighbor base stations to a source base station, the one or more neighbor base stations satisfying a handover (HO) preparation event; receiving, from the source base station, a conditional HO command message of each of at least one of neighbor base stations among the one or more neighbor base stations;

determining a target base station based on priority of a neighbor base station which satisfies a HO execution event among the at least one of neighbor base stations; and performing a handover with the target base station.

The priority may be determined based on whether the conditional HO command message is received or not from a corresponding neighbor base station.

The priority may be configured independently for the one or more neighbor base stations.

The priority may be received from the source base station through the conditional HO command message. The priority may be received from the source base station through a radio resource control (RRC) message in a connection reconfiguration or connection establishment procedure between the source base station and the terminal.

The performing a handover may further comprise, in response to determining that radio resource control (RRC) information of the target base station is invalid, performing a connection reestablishment procedure with the target base station.

The terminal may determine whether the HO preparation event or the HO execution event is satisfied based on signal measurement results in a layer 1 or a layer 3 of the terminal.

Preparation parameters for identifying whether or not the HO preparation event occurs may be different from execution parameters for identifying whether or not the

HO execution event occurs.

The execution parameters for the HO execution event may be configured independently for the one or more neighbor base stations.

According to embodiments of the present disclosure, an operation method of a source base station in a communication system may comprise receiving, from a terminal, a measurement report message of each of one or more neighbor base stations satisfying a handover (HO) preparation event; performing a HO preparation/admission procedure with each of the one or more neighbor base stations; transmitting, to the terminal, a conditional HO command message of each of at least one of neighbor base stations approving a handover of the terminal among the one or more neighbor base stations; and receiving, form the terminal, a HO indication message indicating one neighbor base station satisfying a HO execution event among the at least one of neighbor base stations.

The one neighbor base station may be determined based on priorities of the at least one of neighbor base stations.

The priorities may be configured independently for the at least one of neighbor base stations, and transmitted to the terminal through the conditional HO command message or through a radio resource control (RRC) message in a connection reconfiguration or connection establishment procedure between the source base station and the terminal.

Execution parameters for identifying whether or not the HO execution event occurs may be configured independently for the one or more neighbor base stations, and transmitted to the terminal through the conditional HO command message or through a radio resource control (RRC) message in a connection reconfiguration or connection establishment procedure between the source base station and the terminal.

According to embodiments of the present disclosure, a terminal in a communication system may comprise a processor and a memory storing at least one instruction executed by the processor, and the at least one instruction may be configured to transmit a measurement report message of each of one or more neighbor base stations to a source base station, the one or more neighbor base stations satisfying a handover (HO) preparation event; receive, from the source base station, a conditional HO command message of each of at least one of neighbor base stations among the one or more neighbor base stations; determine a target base station based on priority of a neighbor base station which satisfies a HO execution event among the at least one of neighbor base stations; and perform a handover with the target base station. The priority may be determined based on whether the conditional HO command message is received or not from a corresponding neighbor base station.

The priority may be received from the source base station through the conditional HO command message. The at least one instruction may be further configured to, in response to determining that radio resource control (RRC) information of the target base station is invalid, perform a connection reestablishment procedure with the target base station.

The terminal may determine whether the HO preparation event or the HO execution event is satisfied based on signal measurement results in a layer 1 or a layer 3 of the terminal.

Preparation parameters for identifying whether or not the HO preparation event occurs may be different from execution parameters for identifying whether or not the HO execution event occurs.

The execution parameters for the HO execution event may be configured independently for the one or more neighbor base stations.

According to the embodiments of the present disclosure, a terminal can transmit a measurement report message for each of a plurality of neighbor base stations satisfying a HO preparation event to a source base station, and receive a conditional HO command message for each of the plurality of neighbor base stations from the source base station. When a plurality of neighbor base stations satisfy a HO execution event, the terminal can determine one of the plurality of neighbor base stations as a target base station based on priorities, and transmit a HO indication message indicating the determined target base station to the source base station. The terminal may be handed over from the source base station to the target base station. Since the optimal target base station is determined based on the priorities, handover failures can be minimized. Further, the priorities can be configured by the source base station, in which case the base station can predict the target base station to be selected by the terminal. That is, the handover can be performed according to control of the source base station, so that handover failures can be minimized. Therefore, the performance of the communication system can be improved.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating a first embodiment of a communication system;

FIG. 2 is a block diagram illustrating a first embodiment of a communication node constituting a communication system;

FIG. 3 is a sequence chart illustrating a first embodiment of a conditional handover method in a communication system;

FIG. 4 is a block diagram illustrating an embodiment of a measurement model in a 4G communication system;

FIG. 5 is a block diagram illustrating an embodiment of a measurement model in a 5G communication system;

FIG. 6 is a sequence chart illustrating a first embodiment of a HO preparation/admission procedure in a communication system; and

FIG. 7 is a sequence chart illustrating a second embodiment of a conditional handover method in a communication system.

### DETAILED DESCRIPTION OF THE INVENTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings. In order to facilitate general understanding in describing the present disclosure, the same components in the drawings are denoted with the same reference signs, and repeated description thereof will be omitted.

Hereinafter, a communication system to which embodiments according to the present disclosure will be described. However, the communication systems to which the embodiments according to the present disclosure are applied are not restricted to what will be described below. That is, the embodiments according to the present disclosure may be applied to various communication systems. Here, the communication system may be used in the same sense as a communication network.

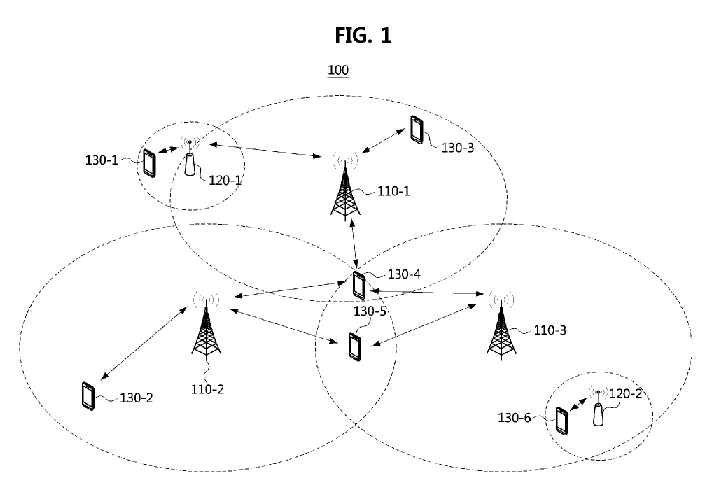

FIG. 1 is a conceptual diagram illustrating a first embodiment of a cellular communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support the 4G communication (e.g., LTE, LTE-Advanced (LTE-A), etc.), the 5G communication (e.g., NR), or the like. The 4G communication may be performed in a frequency band below 6 GHz, and the 5G communication may be performed in a frequency band above 6 GHz as well as the frequency band below 6 GHz.

The plurality of communication nodes may support 4^{th} generation (4G) communication (e.g., long term evolution (LTE), LTE-advanced (LTE-A)), or 5^{th} generation (5G) communication defined in the 3^{rd} generation partnership project (3GPP) standard. The 4G communication may be performed in a frequency band below 6 gigahertz (GHz), and the 5G communication may be performed in a frequency band above 6 GHz. For example, for the 4G and 5G communications, the plurality of communication nodes may support at least one communication protocol among a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, and a space division multiple access (SDMA) based communication protocol.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like. Also, each of the plurality of communication nodes may have the following structure.

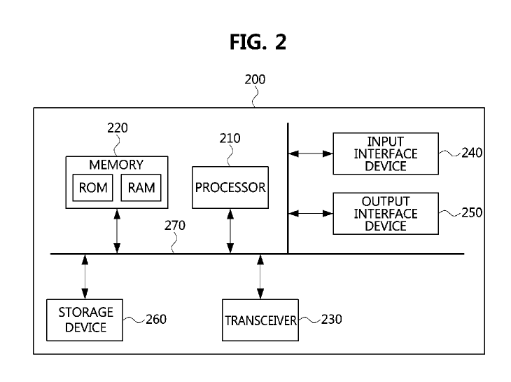

FIG. 2 is a block diagram illustrating a first embodiment of a communication node constituting a cellular communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, or the like. Also, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Also, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, conditional handover methods in the communication system will be described. Even when a method (e.g., transmission or reception of a signal) to be performed at a first communication node among the communication nodes is described, the corresponding second communication node may perform a method (e.g., reception or transmission of the signal) corresponding to the method performed at the first communication node. That is, when an operation of the terminal is described, the corresponding base station may perform an operation corresponding to the operation of the terminal. Conversely, when an operation of the base station is described, the corresponding terminal may perform an operation corresponding to the operation of the base station.

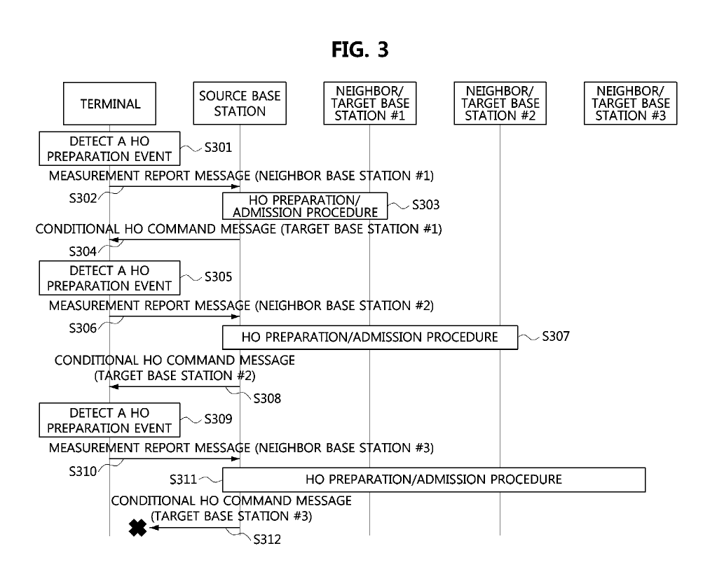

FIG. 3 is a sequence chart illustrating a first embodiment of a conditional handover method in a communication system.

Referring to FIG. 3, a communication system may comprise a terminal, a source base station, a neighbor base station #1, a neighbor base station #2, and a neighbor base station #3. When the neighbor base station #1 is determined as a target base station by the source base station, the neighbor base station #1 may be referred to as a target base station #1. When the neighbor base station #2 is determined as a target base station by the source base station, the neighbor base station #2 may be referred to as a target base station #2. When the neighbor base station #3 is determined as a target base station by the source base station, the neighbor base station #3 may be referred to as a target base station #3.

The terminal may be one of the terminals 130-1, 130-2, 130-3, 130-4, 130-5, and 130-6 shown in FIG. 1, and each of the source base station and the neighbor base stations #1, #2, and #3 may be one of the base stations 110-1, 110-2, 110-3, 120-1, and 120-2 shown in FIG. 1. Each of the terminal, the source base station, the neighbor base station #1, the neighbor base station #2, and the neighbor base station #3 may be configured to be the same as or similar to the communication node 200 shown in FIG. 2.

The terminal may be in a state connected to the source base station. For example, the terminal may operate in a radio resource control (RRC) connected state, and transmit and receive data (e.g., control plane (CP) data, user plane (UP) data) with the source base station. In a connection reconfiguration or connection establishment procedure between the terminal and the source base station, the source base station may transmit an RRC message (e.g., RRC connection reconfiguration message) including measurement configuration information to the terminal. The terminal may identify the measurement configuration information by receiving the RRC message from the source base station.

The measurement configuration information may include measurement object information, report configuration information, measurement identifier (ID), quantity configuration information, and measurement gap information. The measurement object information may include a frequency channel number, a physical cell identifier (PCI), a cell offset, and the like. The report configuration information may include triggering event information. The triggering event information may include handover (HO) preparation event related information (e.g., preparation parameters for a HO preparation event) and/or HO execution event related information (e.g., execution parameters for a HO execution event). For example, the HO execution event related information may include at least one of threshold, offset, Off, Ohoen, and Oreestn which will be described later.

The measurement ID may include an ID for identifying a measurement target. The quantity configuration information may indicate a value measured by the terminal (e.g., reference signal received power (RSRP), reference signal received quality (RSRQ), reference signal-to-interference plus noise ratio (RS-SINR), etc.). The measurement gap may indicate a measurement period of a neighbor cell (e.g., neighbor base station). Also, the measurement configuration information may further include parameters (e.g., Opn and Ohen) used for determining a HO target.

The terminal may measure received signal strengths by receiving signals (e.g., reference signals) from neighbor base stations indicated by the measurement configuration information. For example, the terminal may measure at least one of RSRP, RSRQ, and RS-SINR based on the received signals.

Meanwhile, a measurement model for measuring the received signal strength may be as follows.

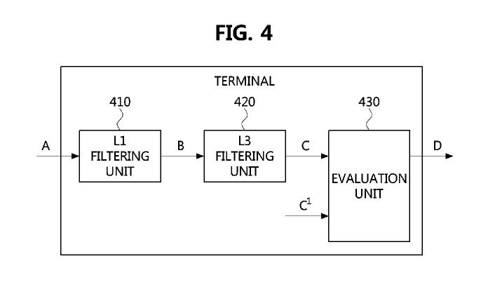

FIG. 4 is a block diagram illustrating an embodiment of a measurement model in a 4G communication system.

As shown in FIG. 4, the terminal may include a layer 1 (L1) filtering unit 410, a layer 3 (L3) filtering unit 420, and an evaluation unit 430 (e.g., evaluation unit for reporting criteria). The L3 filtering unit 420 and the evaluation unit 430 may be included in a layer 3 of the terminal (e.g., RRC layer).

A signal measured at a point A may be an input signal of a PHY layer (e.g., layer 1) included in the terminal. The L1 filtering unit 410 may perform filtering on the signal measured at the point A. A signal at a point B may be a result of the layer 1 filtering on the signal measured at the point A. That is, the signal at the point B may be an input signal of the layer 3 filtering unit 420.

The layer 3 filtering unit 420 may perform filtering on the signal at the point B. Here, parameters for the layer 3 filtering may be configured by RRC signaling. A filtering reporting period at a point C may be the same as one measurement period at the point B. A signal at the point C may be a result of the layer 3 filtering on the signal at the point B. At the point C, the signal may be used as an input signal for evaluation according to reporting criteria. At the point C, a reporting rate may be the same as the reporting rate at the point B.

The evaluation unit 430 may determine whether an actual measurement report is required at a point D. The evaluation unit 430 may perform evaluations based on one or more measurement flows at the point C. For example, the evaluation unit 430 may compare different measures (e.g., input at the point C and input at a point C¹). The evaluation unit 430 may evaluate according to the reporting criteria whenever new measurement results are reported at the points C and C¹. The reporting criteria may be configured by RRC signaling. At the point D, measurement report information (e.g., message) may be transmitted over an air interface.

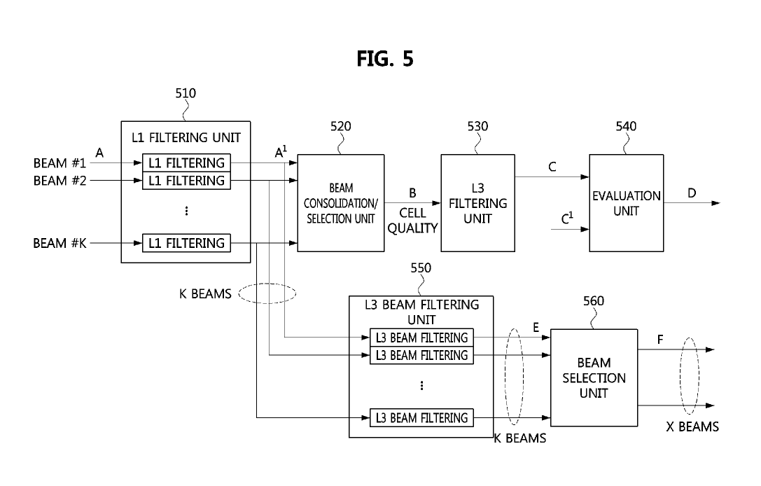

FIG. 5 is a block diagram illustrating an embodiment of a measurement model in a 5G communication system.

As shown in FIG. 5, the terminal may include an L1 filtering unit 510, a beam consolation/selection unit 520, an L3 filtering unit 530, an evaluation unit 540, an L3 beam filtering unit 550, and a beam selection unit 560. The beam consolation/selection unit 520, the L3 filtering unit 530, the evaluation unit 540, the L3 beam filtering unit 550, and the beam selection unit 560 may be included in a layer 3 of the terminal (e.g., RRC layer).

Signals measured at a point A may be input signals of a PHY layer (e.g., layer 1) included in the terminal. The L1 filtering unit 510 may perform filtering on the signals measured at the point A. Also, signals at a point A¹ may be results of the layer 1 filtering on the signals measured at the point A. That is, the signals at the point A¹ may be input signals of the beam consolidation/selection unit 520.

The beam consolidation/selection unit 520 may consolidate beam-specific measurements to derive a cell quality. Alternatively, the beam consolidation/selection unit 520 may select an optimal beam measurement to derive the cell quality. The parameters for operations performed in the beam consolidation/selection unit 520 may be configured by RRC signaling. A reporting period at a point B may be the same as the measurement period at the point A¹.

The signal at the point B may be an output signal of the beam consolidation/selection unit 520 and reported to the layer 3 filtering unit 530. The layer 3 filtering unit 530 may perform layer 3 filtering on the cell quality. The layer 3 filtering unit 530 may perform filtering on the input signal at the point B. The parameters for operations performed in the layer 3 filtering unit 530 may be configured by RRC signaling. A filtering reporting period at a point C may be the same as one measurement period at the point B. The signal at the point C may be an output signal of the L3 filtering unit 530. A reporting rate at the point C may be the same as the reporting rate at the point B. At the point C, the signal may be used as an input signal for evaluation according to reporting criteria.

The evaluation unit 540 may determine whether an actual measurement report is required at a point D. The evaluation unit 540 may perform evaluations based on one or more measurement flows at the point D. For example, the evaluation unit 430 may compare different measures (e.g., input at the point C and input at a point C¹). The evaluation unit 540 may evaluate according to the reporting criteria whenever new measurement results are reported at the points C and C¹. The reporting criteria may be configured by RRC signaling. At the point D, measurement report information (e.g., message) may be transmitted over an air interface.

The L3 beam filtering unit 550 may perform filtering on the signals at the point A¹. The parameters for operations performed in the L3 beam filtering unit 550 may be configured by RRC signaling. A filtering reporting period at a point E may be the same as one measurement period at the point A¹.

Signals at a point E may be output signals of the L3 beam filtering unit 530. A reporting rate at the point E may be the same as the reporting rate at the point A¹. The signals at the point E (e.g., the output signal of the L3 beam filtering unit 550) may be used as input signals to select X measurements at the beam selection unit 560.

The beam selection unit 560 may select beams (e.g., measurements) for beam reporting. The beam selection unit 560 may select X measurements from the signals (e.g., measurements) at the point E. The parameters for operations performed in the beam selection unit 560 may be configured by RRC signaling. At a point F, signals may be beam measurement information. A measurement report including the beam measurement information may be transmitted over an air interface.

Referring back to FIG. 3, the terminal may determine whether a HO preparation event for the neighbor base station #1 is generated based on the signal received from the neighbor base station #1. For example, the terminal may determine whether one of HO preparation events A1 to A6 and B1 and B2 occurs.

▪ HO Preparation Event A1

When a signal measurement result Ms of the source base station satisfies Equation 1 below at a preconfigured period (e.g., time-to-prepare (TTP)), the terminal may determine that a HO preparation event A1 occurs. Here, the TTP may be 0.

Ms−Hys>threshold [Equation 1]

Ms may be the signal at the point A, the signal at the point A¹, the signal at the point B, or the signal at the point C in FIGS. 4 and 5. Alternatively, Ms may be a weighted value of each of the signals of the points A, A¹, B and C. A hysteresis Hys may indicate a margin for the HO preparation event A1 and may be a value within 0 dB to 30 dB. A threshold for the HO preparation event A1 may be configured to be different from a threshold for a HO execution event A1 to be described later.

▪ HO Preparation Event A2

When a signal measurement result Ms of the source base station satisfies Equation 2 below at a preconfigured period (e.g., TTP), the terminal may determine that a HO preparation event A2 occurs. Here, the TTP may be 0.

Ms+Hys<threshold [Equation 2]

Ms may be the signal at the point A, the signal at the point A¹, the signal at the point B, or the signal at the point C in FIGS. 4 and 5. Alternatively, Ms may be a weighted value of each of the signals of the points A, A¹, B and C. A hysteresis Hys may indicate a margin for the HO preparation event A2 and may be a value within 0 dB to 30 dB. A threshold for the HO preparation event A2 may be configured to be different from a threshold for a HO execution event A2 to be described later. For example, the threshold for the HO preparation event A2 may be greater than or equal to the threshold for HO execution event A2.

▪ HO Preparation Event A3

When a signal measurement result Ms of the source base station and a signal measurement result Mn of a neighbor base station (e.g., neighbor base station #1) satisfy Equation 3 below at a preconfigured period (e.g., TTP), the terminal may determine that a HO preparation event A3 occurs. Here, the TTP may be 0.

Mn+Ofn+Ocn−Hys>Ms+Ofs+Ocs+Off [Equation 3]

Each of Ms and Mn may be the signal at the point A, the signal at the point A¹, the signal at the point B, or the signal at the point C in FIGS. 4 and 5. Alternatively, each of Ms and Mn may be a weighted value of each of the signals of the points A, A¹, B and C. Ofn may be a frequency specific offset of the neighbor base station. Ocn may be a cell specific offset of the neighbor base station. Ofs may be a frequency specific offset of the source base station. Ocs may be a cell specific offset of the source base station. A hysteresis Hys may indicate a margin for the HO preparation event A3. Off may be an offset for the HO preparation event A3. Off for the HO preparation event A3 may be configured to be different from Off for a HO execution event A3 to be described later. For example, Off for the HO preparation event A3 may be less than Off for the HO execution event A3.

▪ HO Preparation Event A4

When a signal measurement result Mn of a neighbor base station (e.g., neighbor base station #1) satisfies Equation 4 below at a preconfigured period (e.g., TTP), the terminal may determine that a HO preparation event A4 occurs. Here, the TTP may be 0.

Mn+Ofn+Ocn−Hys>threshold [Equation 4]

Mn may be the signal at the point A, the signal at the point A¹, the signal at the point B, or the signal at the point C in FIGS. 4 and 5. Alternatively, Mn may be a weighted value of each of the signals of the points A, A¹, B and C. Ofn may be a frequency specific offset of the neighbor base station. Ocn may be a cell specific offset of the neighbor base station. Hys may indicate a margin for the HO preparation event A4, and may have a value within 0 dB to 30 dB. A threshold for the HO preparation event A4 may be configured to be different from a threshold for a HO execution event A4 to be described later.

▪ HO Preparation Event A5

When a signal measurement result Ms of the source base station and a signal measurement result Mn of a neighbor base station (e.g., neighbor base station #1) satisfy Equation 5 below at a preconfigured period (e.g., TTP), the terminal may determine that a HO preparation event A5 occurs. Here, the TTP may be 0.

Ms+Hys<threshold 1

Mn+Ofn+Ocn−Hys>threshold 2 [Equation 5]

Each of Ms and Mn may be the signal at the point A, the signal at the point A¹, the signal at the point B, or the signal at the point C in FIGS. 4 and 5. Alternatively, each of Ms and Mn may be a weighted value of each of the signals of the points A, A¹, B and C. A hysteresis Hys may indicate a margin for the HO preparation event A5. Ofn may be a frequency specific offset of the neighbor base station. Ocn may be a cell specific offset of the neighbor base station. Thresholds for the HO preparation event A5 may be configured to be different from thresholds for a HO execution event A5 to be described later.

▪ HO Preparation Event A6

When a signal measurement result Ms of the source base station and a signal measurement result Mn of a neighbor base station (e.g., neighbor base station #1) satisfy Equation 6 below at a preconfigured period (e.g., TTP), the terminal may determine that a HO preparation event A6 occurs. Here, the TTP may be 0.

Mn+Ocn−Hys>Ms+Ocs+Off [Equation 6]

Each of Ms and Mn may be the signal at the point A, the signal at the point A¹, the signal at the point B, or the signal at the point C in FIGS. 4 and 5. Alternatively, each of Ms and Mn may be a weighted value of each of the signals of the points A, A¹, B and C. Hys may indicate a margin for the HO preparation event A6. Ocn may be a cell specific offset of the neighbor base station. Ocs may be a cell specific offset of the source base station. Off for the HO preparation event A6 may be configured to be different from Off for a HO execution event A6 to be described later.

▪ HO Preparation Event B1

When a signal measurement result Mn of a neighbor base station (e.g., neighbor base station #1) satisfies Equation 7 below at a preconfigured period (e.g., TTP), the terminal may determine that a HO preparation event B1 occurs. Here, the TTP may be 0.

Mn+Ofn−Hys>threshold [Equation 7]

Mn may be the signal at the point A, the signal at the point A¹, the signal at the point B, or the signal at the point C in FIGS. 4 and 5. Alternatively, Mn may be a weighted value of each of the signals of the points A, A¹, B and C. Ofn may be a frequency specific offset of the neighbor base station. Hys may indicate a margin for the HO preparation event B1. A threshold for the HO preparation event B1 may be configured to be different from a threshold for a HO execution event B1 to be described later.

▪ HO Preparation Event B2

When a signal measurement result Ms of the source base station and a signal measurement result Mn of a neighbor base station (e.g., neighbor base station #1) satisfy Equation 8 below at a preconfigured period (e.g., TTP), the terminal may determine that a HO preparation event B2 occurs. Here, the TTP may be 0.

Ms+Hys<threshold 1

Mn+Ofn+Hys>threshold 2 [Equation 8]

Each of Ms and Mn may be the signal at the point A, the signal at the point A¹, the signal at the point B, or the signal at the point C in FIGS. 4 and 5. Alternatively, each of Ms and Mn may be a weighted value of each of the signals of the points A, A¹, B and C. Hys may indicate a margin for the HO preparation event B2. Ofn may be a frequency specific offset of the neighbor base station. Thresholds for the HO preparation event B2 may be configured to be different from thresholds for a HO execution event B2 to be described later.

Meanwhile, when it is determined that the HO preparation event occurs according to the signal measurement result of the neighbor base station #1, the terminal may generate a measurement report message and transmit the generated measurement report message to the source base station (S302). The measurement report message may include at least one of the signal measurement result of the source base station, the signal measurement result of the neighbor base station #1, a PCI, a tracking area identifier (TAI), an E-UTRAN cell global identifier (ECGI), and the generated HO preparation event of the neighbor base station #1.

Upon receiving the measurement report message from the terminal, the source base station may determine that the HO preparation event for the neighbor base station #1 occurs. The source base station may determine whether to determine the neighbor base station #1 as a handover target base station based on the information included in the measurement report message. When the neighbor base station #1 is determined as a target base station #1, the source base station may perform a HO preparation/admission procedure with the target base station #1 (S303). The HO preparation/admission procedure may be performed as follows.

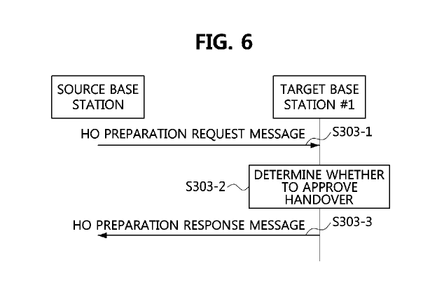

FIG. 6 is a sequence chart illustrating a first embodiment of a HO preparation/admission procedure in a communication system.

As shown in FIG. 6, the source base station may generate a HO preparation request message and transmit the HO preparation request message to the target base station #1 (S303-1). The HO preparation request message may include context information of the terminal. The context information of the terminal may include security context information and quality of service (QoS) context information.

The target base station #1 may receive the HO preparation request message from the source base station, and determine whether to approve the handover based on the information included in the HO preparation request message (S303-2). For example, the target base station #1 may confirm whether a specific service quality can be provided to the terminal based on the context information included in the HO preparation request message. When it is possible to provide the terminal with the specific service quality, the target base station #1 may perform an RRC configuration operation for the terminal, and transmit a HO preparation response message including RRC configuration information to the source base station (S303-3). The HO preparation response message may indicate that the HO is approved. The source base station may receive the HO preparation response message from the target base station #1, and identify the information included in the HO preparation response message. That is, when the HO preparation response message is received, the source base station may determine that the HO is approved by the target base station #1.

Referring again to FIG. 3, the source base station may generate a conditional HO command message (e.g., early HO command message), and may transmit the conditional HO command message to the terminal (S304). The conditional HO command message may indicate that the HO is approved by the target base station #1. Also, the conditional HO command message may include RRC configuration information of the target base station #1 and HO execution event related information (e.g., parameters for the HO execution event). For example, the HO execution event related information may include at least one of a threshold value, an offset, off, Ohoen, and Oreestn to be described later. The HO execution event related information may be transmitted through an RRC message in the connection reconfiguration or connection establishment procedure between the terminal and the source base station instead of the conditional HO command message.

The terminal may receive the conditional HO command message from the source base station, and identify the information included in the conditional HO command message. In this case, the terminal may determine that HO is approved by the target base station #1.

Meanwhile, the terminal may determine whether a HO preparation event for the neighbor base station #2 occurs based on the signal received from the neighbor base station #2 (S305). For example, the terminal may determine whether one of the HO preparation events A1 to A6 and B1 and B2 occurs based on Equations 1 to 8. When it is determined that the HO preparation event occurs according to the signal measurement result of the neighbor base station #2, the terminal may generate a measurement report message, and transmit the generated measurement report message to the source base station (S306). The measurement report message may include at least one of the signal measurement result of the source base station, the signal measurement result of the neighbor base station #2, a PCI, a TAI, an ECGI, and the generated HO preparation event of the neighbor base station #2.

Upon receiving the measurement report message from the terminal, the source base station may determine that a HO preparation event for the neighbor base station #2 occurs. The source base station may determine whether to determine the neighbor base station #2 as a handover target base station based on the information included in the measurement report message. When the neighbor base station #2 is determined as a target base station #2, the source base station may perform a HO preparation/admission procedure with the target base station #2 (S307). The HO preparation/admission procedure may be performed in the same or similar manner as the embodiment shown in FIG. 6.

When the HO preparation/admission procedure is completed (i.e., when the target base station #2 approves handover of the terminal), the source base station may generate a conditional HO command message (e.g., early HO command message), and may transmit the conditional HO command message to the terminal (S308). The conditional HO command message may indicate that the HO is approved by the target base station #2. Also, the conditional HO command message may include RRC configuration information of the target base station #2 and HO execution event related information (e.g., a threshold value, an offset, off, Ohoen, and Oreestn). The HO execution event related information may be transmitted through an RRC message in the connection reconfiguration or connection establishment procedure between the terminal and the source base station instead of the conditional HO command message.

The terminal may receive the conditional HO command message from the source base station, and identify the information included in the conditional HO command message. In this case, the terminal may determine that the HO is approved by the target base station #2.

Meanwhile, the terminal may determine whether a HO preparation event for the neighbor base station #3 occurs based on the signal received from the neighbor base station #3 (S309). For example, the terminal may determine whether one of HO preparation events A1 to A6 and B1 and B2 occurs based on Equations 1 to 8. When it is determined that the HO preparation event occurs according to the signal measurement result of the neighbor base station #3, the terminal may generate a measurement report message, and transmit the generated measurement report message to the source base station (S310). The measurement report message may include at least one of the signal measurement result of the source base station, the signal measurement result of the neighbor base station #3, a PCI, a TAI, an ECGI, and the generated HO preparation event of the neighbor base station #3.

Upon receiving the measurement report message from the terminal, the source base station may determine that a HO preparation event for the neighbor base station #3 occurs. The source base station may determine whether to determine the neighbor base station #3 as a handover target base station based on the information included in the measurement report message. When the neighbor base station #3 is determined as a target base station #3, the source base station may perform a HO preparation/admission procedure with the target base station #3 (S311). The HO preparation/admission procedure may be performed in the same or similar manner as the embodiment shown in FIG. 6.

When the HO preparation/admission procedure is completed (i.e., when the target base station #3 approves handover of the terminal), the source base station may generate a conditional HO command message (e.g., early HO command message), and may transmit the conditional HO command message to the terminal (S312). The conditional HO command message may indicate that the HO is approved by the target base station #3. Also, the conditional HO command message may include RRC configuration information and HO execution event related information (e.g., a threshold value, an offset, off, Ohoen, and Oreestn) of the target base station #3. The HO execution event related information may be transmitted through an RRC message in the connection reconfiguration or connection establishment procedure between the terminal and the source base station instead of the conditional HO command message.

However, when a channel condition between the terminal and the source base station is not good at the time of transmitting the conditional HO command message, the terminal may not receive the conditional HO command message for the target base station #3 from the source base station.

Meanwhile, after the embodiment shown in FIG. 3 is completed, a HO execution event may be detected as follows. The following embodiment will be described assuming that reception states of the conditional HO command messages are as shown in Table 1 below.

TABLE 1

| | Reception state of the conditional |
|---|---|
| | HO command message |
| Target base station #1 | Received |
| Target base station #2 | Received |
| Target base station #3 | Not received |

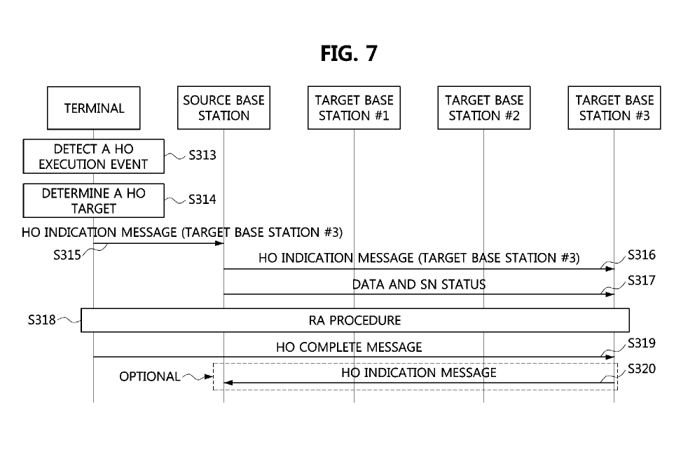

FIG. 7 is a sequence chart illustrating a second embodiment of a conditional handover method in a communication system.

The embodiment shown in FIG. 7 may be performed after the embodiment shown in FIG. 3. The terminal may determine whether a HO execution event occurs or not based on signals received from the target base stations #1 to #3 (S313). For example, the terminal may determine whether one of HO execution events A1 to A6 and B1 and B2 occurs based on the signal measurement result Ms of the source base station and/or the signal measurement result Mn of the target base station. Here, each of Ms and Mn may be the signal at the point A, the signal at the point A¹, the signal at the point B, or the signal at the point C in FIGS. 4 and 5. Alternatively, each of Ms and Mn may be a weighted value of each of the signals of the points A, A¹, B and C.

▪ HO Execution Event A1

When a signal measurement result Ms of the source base station satisfies Equation 1 below at a preconfigured period (e.g., time-to-execute (TTE)), the terminal may determine that a HO execution event A1 occurs for at least one of the target base stations #1 to #3. TTE may be 0. A threshold for the HO execution event A1 may be equal to or greater than the threshold for the HO preparation event A1. The threshold for the HO execution event A1 may be the same value in all cells (e.g., all base stations). Alternatively, the threshold for the HO execution event A1 may be configured for each cell (e.g., each of all base stations).

▪ HO Execution Event A2

When a signal measurement result Ms of the source base station satisfies Equation 2 below at a preconfigured period (e.g., TTE), the terminal may determine that a HO execution event A2 occurs for at least one of the target base stations #1 to #3. TTE may be 0. A threshold for the HO execution event A2 may be equal to or less than the threshold for the HO preparation event A2. The threshold for the HO execution event A2 may be the same value in all cells (e.g., all base stations). Alternatively, the threshold for the HO execution event A2 may be configured for each cell (e.g., each of all base stations).

▪ HO Execution Event A3

Case 1: When the Conditional HO Command Message is Received

When signal measurement results of the source base station and the target base station satisfy Equation 9 below at a preconfigured period (e.g., TTE), the terminal may determine that a HO execution event A3 occurs for the target base station #1 and/or the target base station #3. TTE may be 0.

Mn+Ofn+Ocn−Hys>Ms+Ofs+Ocs+Ohoen [Equation 9]

Ohoen may be an offset for the HO execution event A3, and may be expressed in dB. Ohoen may be the same value in all cells (e.g., all base stations). Alternatively, Ohoen may be configured for each cell (e.g., each of all base stations).

Case 2: When the Conditional HO Command Message is Not Received

When signal measurement results of the source base station and the target base station satisfy Equation 10 below at a preconfigured interval (e.g., TTE), the terminal may determine that a HO execution event A3 occurs for the target base station #2. TTE may be 0.

Mn+Ofn+Ocn−Hys>Ms+Ofs+Ocs+Oreestn [Equation 10]

Oreestn may be an offset for the HO execution event A3, and may be expressed in dB. Oreestn may be equal to or greater than Ohoen. Oreestn may be the same value in all cells (e.g., all base stations). Alternatively, Oreestn may be configured for each cell (e.g., each of all base stations).

▪ HO Execution Event A4

Case 1: When the Conditional HO Command Message is Received

When a signal measurement result Ms of the target base station satisfies Equation 11 below at a preconfigured period (e.g., TTE), the terminal may determine that a HO execution event A4 occurs for the target base station #1 and/or the target base station #3. TTE may be 0.

Mn+Ofn+Ocn−Hys>threshold+Ohoen [Equation 11]

Ohoen may be an offset for the HO execution event A4, and may be expressed in dB. Ohoen may be the same value in all cells (e.g., all base stations). Alternatively, Ohoen may be configured for each cell (e.g., each of all base stations).

Case 2: When the Conditional HO Command Message is Not Received

When a signal measurement result of the target base station satisfies Equation 12 below at a preconfigured period (e.g., TTE), the terminal may determine that a HO execution event A4 occurs for the target base station #2. TTE may be 0.

Mn+Ofn+Ocn−Hys>threshold+Oreestn [Equation 12]

Oreestn may be an offset for the HO execution event A4, and may be expressed in dB. Oreestn may be equal to or greater than Ohoen. Oreestn may be the same value in all cells (e.g., all base stations). Alternatively, Oreestn may be configured for each cell (e.g., each of all base stations).

▪ HO Execution Event A5

Case 1: When the Conditional HO Command Message is Received

When signal measurement results of the source base station and the target base station satisfy Equation 12 below at a preconfigured period (e.g., TTE), the terminal may determine that a HO execution event A5 occurs for the target base station #1 and/or the target base station #3. TTE may be 0.

Ms+Hys<threshold 1

Mn+Ofn+Ocn−Hys>threshold 2+Ohoen [Equation 13]

Ohoen may be an offset for the HO execution event A5, and may be expressed in dB. Ohoen may be the same value in all cells (e.g., all base stations). Alternatively, Ohoen may be configured for each cell (e.g., each of all base stations).

Case 2: When the Conditional HO Command Message is Not Received

When signal measurement results of the source base station and the target base station satisfy Equation 14 below at a preconfigured period (e.g., TTE), the terminal may determine that a HO execution event A5 occurs for the target base station #2. TTE may be 0.

Ms+Hys<threshold 1

Mn+Ofn+Ocn−Hys>threshold 2+Oreestn [Equation 14]

Oreestn may be an offset for the HO execution event A5, and may be expressed in dB. Oreestn may be equal to or greater than Ohoen. Oreestn may be the same value in all cells (e.g., all base stations). Alternatively, Oreestn may be configured for each cell (e.g., each of all base stations).

▪ HO Execution Event A6

Case 1: When the Conditional HO Command Message is Received

When signal measurement results of the source base station and the target base station satisfy Equation 15 below at a preconfigured period (e.g., TTE), the terminal may determine that a HO execution event A6 occurs for the target base station #1 and/or the target base station #3. TTE may be 0.

Mn+Ocn−Hys>Ms+Ocs+Off+Ohoen [Equation 15]

Ohoen may be an offset for the HO execution event A6, and may be expressed in dB. Ohoen may be the same value in all cells (e.g., all base stations). Alternatively, Ohoen may be configured for each cell (e.g., each of all base stations).

Case 2: When the Conditional HO Command Message is Not Received

When signal measurement results of the source base station and the target base station satisfy Equation 16 below at a preconfigured period (e.g., TTE), the terminal may determine that a HO execution event A6 for the target base station #2 occurs. TTE may be 0.

Mn+Ocn−Hys>Ms+Ocs+Off+Oreestn [Equation 16]

Oreestn may be an offset for the HO execution event A6, and may be expressed in dB. Oreestn may be equal to or greater than Ohoen. Oreestn may be the same value in all cells (e.g., all base stations). Alternatively, Oreestn may be configured for each cell (e.g., each of all base stations).

▪ HO Execution Event B1

Case 1: When the Conditional HO Command Message is Received

When a signal measurement result of the target base station satisfies Equation 17 below at a preconfigured period (e.g., TTE), the terminal may determine that a HO execution event B1 occurs for the target base station #1 and/or the target base station #3. TTE may be 0.

Mn+Ofn−Hys>threshold+Ohoen [Equation 17]

Ohoen may be an offset for the HO execution event B1, and may be expressed in dB. Ohoen may be the same value in all cells (e.g., all base stations). Alternatively, Ohoen may be configured for each cell (e.g., each of all base stations).

Case 2: When the Conditional HO Command Message is Not Received

When a signal measurement result of the target base station satisfies Equation 18 below at a preconfigured period (e.g., TTE), the terminal may determine that a HO execution event B1 for the target base station #2 occurs. TTE may be 0.

Mn+Ofn−Hys>threshold+Oreestn [Equation 18]

Oreestn may be an offset for the HO execution event B1, and may be expressed in dB. Oreestn may be equal to or greater than Ohoen. Oreestn may be the same value in all cells (e.g., all base stations). Alternatively, Oreestn may be configured for each cell (e.g., each of all base stations).

▪ HO Execution Event B2

Case 1: When the Conditional HO Command Message is Received

When signal measurement results of the source base station and the target base station satisfy Equation 19 below at a preconfigured period (e.g., TTE), the terminal may determine that a HO execution event B2 for the target base station #1 and/or the target base station #3 occurs. TTE may be 0.

Ms+Hys<threshold 1

Mn+Ofn+Hys>threshold 2+Ohoen [Equation 19]

Ohoen may be an offset for the HO execution event B2, and may be expressed in dB. Ohoen may be the same value in all cells (e.g., all base stations). Alternatively, Ohoen may be configured for each cell (e.g., each of all base stations).

Case 2: When the Conditional HO Command Message is Not Received

When signal measurement results of the source base station and the target base station satisfy Equation 20 below at a preconfigured period (e.g., TTE), the terminal may determine that a HO execution event B2 for the target base station #2 occurs. TTE may be 0.

Ms+Hys<threhold 1

Mn+Ofn+Hys>threshold 2+Oreestn [Equation 20]

Oreestn may be an offset for the HO execution event B2, and may be expressed in dB. Oreestn may be equal to or greater than Ohoen. Oreestn may be the same value in all cells (e.g., all base stations). Alternatively, Oreestn may be configured for each cell (e.g., each of all base stations).

In Equations 19 to 20, Ohoen and Oreestn may be configured according to a channel state between the terminal and the source base station. For example, Ohoen when the channel state between the terminal and the source base station is equal to or higher than a preconfigured level may be greater than Ohoen when the channel state between the terminal and the source base station is less than the preconfigured level. Oreestn when the channel state between the terminal and the source base station is equal to or higher than a preconfigured level may be greater than Oreestn when the channel state between the terminal and the source base station is less than the preconfigured level. Ohoen and Oreestn configured by the source base station may be included in the conditional HO command message or the RRC message (e.g., the RRC message in the connection reconfiguration or connection establishment procedure between the terminal and the source base station) transmitted from the source base station to the terminal.

On the other hand, when it is determined in the step S313 that HO execution events have occurred in a plurality of target base stations, the terminal may determine one HO target (e.g., one target base station) among the plurality of target base stations (S314). When it is determined in the step S313 that a HO execution event occurs in a single target base station, the terminal may be handed over to the target base station without performing the step S314.

▪ HO Target Determination Scheme #1

The terminal may select one target base station from among a plurality of target base stations for which the HO execution event occurs based on Equation 21 regardless of reception of the conditional HO command message. For example, the terminal may select one target base station having the maximum (Mn+Ofn+Ocn+Opn) among the plurality of target base stations.

MAX(Mn+Ofn+Ocn+Opn) [Equation 21]

Opn may be an offset indicating the priority of the corresponding target base station, and may be expressed in dB. Opn may be the same in all target base stations. Alternatively, Opn may be configured differently for each target base station. Opn may be transmitted through the RRC message or the conditional HO command message in the connection reconfiguration or connection establishment procedure between the terminal and the source base station. That is, Opn may be configured by the source base station.

Alternatively, Opn may be configured based on preference of the terminal. For example, the terminal may set Opn of a preferred target base station to a relatively large value, and Opn of an unpreferred target base station to a relatively small value.

▪ HO Target Determination Scheme #2

The terminal may select one target base station from among a plurality of target base stations for which the HO execution event occurs based on Equation 22. For example, the terminal may select one target base station having the maximum (Mn+Ofn+Ocn+Opn+Ohen) among the plurality of target base stations. Alternatively, Opn may be omitted in Equation 22, and in this case, the terminal may select one target base station having the maximum of (Mn+Ofn+Ocn+Ohen).

MAX(Mn+Ofn+Ocn+Opn+Ohen) [Equation 22]

Opn may be an offset indicating the priority of the target base station. In the case that the conditional HO command message for a specific cell (e.g., specific base station) is received, Ohen may be an offset which is used for increasing priority of the specific cell in a step at which the target cell (e.g., target base station) is determined as a final handover target. Ohen may be expressed in dB. Ohen may be transmitted through the conditional HO command message or the RRC message in the connection reconfiguration or connection establishment procedure between the terminal and the source base station. That is, Ohen may be configured by the source base station.

Alternatively, Ohen may be configured by the terminal. A range of Ohen may be configured by the base station, and in this case, the terminal may determine Ohen within the range configured by the base station.

When one target base station is determined in the step S314, the terminal may be handed over to the target base station. When the conditional HO command message for the target base station determined in the step S314 is not received (e.g., when the RRC configuration information of the target base station is invalid), the terminal may perform a connection reestablishment procedure with the target base station. On the other hand, when the conditional HO command message for the target base station determined in the step S314 is received, the terminal may use the RRC configuration information included in the conditional HO command message. Alternatively, even when the conditional HO command message for the target base station determined in the step S314 is received, if the RRC configuration information of the target base station is invalid, the terminal may perform a connection reestablishment procedure with the target base station.

When the target base station #3 is determined as the HO target in step the S314, the terminal may generate a HO indication message including identification information (e.g., PCI) of the target base station #3, and transmit the HO indication message to the source base station (S315). The HO indication message may indicate that the target base station #3 is determined as the HO target. Upon receiving the HO indication message from the terminal, the base station may determine that the target base station #3 is determined as the HO target in the step S314. Accordingly, the base station may transmit a HO indication message to the target base station #3 (S316). The target base station #3 may receive the HO indication message from the source base station, and determine that the terminal is to be handed over to the target base station #3 based on the HO indication message. Then, the source base station may transfer data and sequence number (SN) status information of the terminal to the target base station #3 (S317). The target base station #3 may receive the data and SN status information from the source base station.

The terminal may perform a random access (RA) procedure with the target base station #3 (S318). In the RA procedure, the terminal may acquire uplink synchronization with the target base station #3. After the RA procedure is completed, the terminal may transmit a HO complete message to the target base station #3 (S319). The target base station #3 may receive the HO complete message from the terminal. When the HO indication message is not received from the source base station in the step S316, the target base station #3 may transmit a HO indication message (or HO notification message) to the source base station if necessary (S320). Upon receiving the HO complete message from the target base station #3, the source base station may determine that the handover of the terminal is completed, and release the connection between the source base station and the terminal.

On the other hand, the step S313 may be performed after the step S314 is performed first. In this case, the terminal may select one target base station, and when the selected target base station satisfies the HO execution event, the terminal may be handed over to the selected target base station. The embodiments described above may be applied not only to handover for changing a primary cell (PCell), but also to handover for changing a secondary cell (SCell) in a communication system supporting carrier aggregation (CA). In addition, the above-described embodiments may be applied to handover in which a primary secondary cell (PSCell) or an SCell is changed in a communication system supporting dual connectivity (DC).

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a terminal in a communication system, the operation method comprising:
transmitting a measurement report message of each of one or more neighbor base stations to a source base station, the one or more neighbor base stations satisfying a handover (HO) preparation event;
receiving, from the source base station, a conditional HO command message of each of at least one of neighbor base stations among the one or more neighbor base stations;
determining a target base station based on priority of a neighbor base station which satisfies a HO execution event among the at least one of neighbor base stations; and
performing a handover with the target base station.

2. The operation method according to claim 1, wherein the priority is determined based on whether the conditional HO command message is received or not from a corresponding neighbor base station.

3. The operation method according to claim 1, wherein the priority is configured independently for the one or more neighbor base stations.

4. The operation method according to claim 1, wherein the priority is received from the source base station through the conditional HO command message.

5. The operation method according to claim 1, wherein the priority is received from the source base station through a radio resource control (RRC) message in a connection reconfiguration or connection establishment procedure between the source base station and the terminal.

6. The operation method according to claim 1, wherein the performing a handover further comprise, in determination that radio resource control (RRC) information of the target base station is invalid, performing a connection reestablishment procedure with the target base station.

7. The operation method according to claim 1, wherein the terminal determines whether the HO preparation event or the HO execution event is satisfied based on signal measurement results in a layer 1 or a layer 3 of the terminal.

8. The operation method according to claim 1, wherein preparation parameters for identifying whether or not the HO preparation event occurs are different from execution parameters for identifying whether or not the HO execution event occurs.

9. The operation method according to claim 8, wherein the execution parameters for the HO execution event are configured independently for the one or more neighbor base stations.

10. An operation method of a source base station in a communication system, the operation method comprising:
receiving, from a terminal, a measurement report message of each of one or more neighbor base stations satisfying a handover (HO) preparation event;
performing a HO preparation/admission procedure with each of the one or more neighbor base stations;
transmitting, to the terminal, a conditional HO command message of each of at least one of neighbor base stations approving a handover of the terminal among the one or more neighbor base stations; and
receiving, form the terminal, a HO indication message indicating one neighbor base station satisfying a HO execution event among the at least one of neighbor base stations.

11. The operation method according to claim 10, wherein the one neighbor base station is determined based on priorities of the at least one of neighbor base stations.

12. The operation method according to claim 11, wherein the priorities are configured independently for the at least one of neighbor base stations, and transmitted to the terminal through the conditional HO command message or through a radio resource control (RRC) message in a connection reconfiguration or connection establishment procedure between the source base station and the terminal.

13. The operation method according to claim 10, wherein execution parameters for identifying whether or not the HO execution event occurs are configured independently for the one or more neighbor base stations, and transmitted to the terminal through the conditional HO command message or through a radio resource control (RRC) message in a connection reconfiguration or connection establishment procedure between the source base station and the terminal.

14. A terminal in a communication system, the terminal comprising a processor and a memory storing at least one instruction executed by the processor, wherein the at least one instruction is configured to:
transmit a measurement report message of each of one or more neighbor base stations to a source base station, the one or more neighbor base stations satisfying a handover (HO) preparation event;
receive, from the source base station, a conditional HO command message of each of at least one of neighbor base stations among the one or more neighbor base stations;
determine a target base station based on priority of a neighbor base station which satisfies a HO execution event among the at least one of neighbor base stations; and
perform a handover with the target base station.

15. The terminal according to claim 14, wherein the priority is determined based on whether the conditional HO command message is received or not from a corresponding neighbor base station.

16. The terminal according to claim 14, wherein the priority is received from the source base station through the conditional HO command message.

17. The terminal according to claim 14, wherein the at least one instruction is further configured to, in determination that radio resource control (RRC) information of the target base station is invalid, perform a connection reestablishment procedure with the target base station.

18. The terminal according to claim 14, wherein the terminal determines whether the HO preparation event or the HO execution event is satisfied based on signal measurement results in a layer 1 or a layer 3 of the terminal.

19. The terminal according to claim 14, wherein preparation parameters for identifying whether or not the HO preparation event occurs are different from execution parameters for identifying whether or not the HO execution event occurs.

20. The terminal according to claim 19, wherein the execution parameters for the HO execution event are configured independently for the one or more neighbor base stations.
